(19) United States
(12) Patent Application Publication
(10) Pub. No.: US 2024/0359259 A1
(43) Pub. Date: Oct. 31, 2024

(54) LASER WELDING METHOD AND LASER WELDING SYSTEM

(71) Applicant: Honda Motor Co., Ltd., Tokyo (JP)

(72) Inventors: Ryuzo Sakamoto, Saitama (JP); Takashi Kobayashi, Tokyo (JP); Toru Eguchi, Saitama (JP)

(21) Appl. No.: 18/630,225

(22) Filed: Apr. 9, 2024

(30) Foreign Application Priority Data
Apr. 25, 2023 (JP) 2023-071766

(51) Int. Cl. B23K 26/046; B23K 101/38; G02B 27/10

(52) U.S. Cl. CPC B23K 26/046; B23K 2101/38; G02B 27/10

(57) ABSTRACT

A laser welding method includes: a first step of irradiating a target with a first laser beam; and a second step of irradiating a melting region melted in the first step with a second laser beam to maintain a melting amount of the melting region. The first laser beam is irradiated in a first configuration in which an output of the first laser beam is lowered by a predetermined amount when a predetermined time elapses, and an output of the second laser beam is set to be smaller than the output of the first laser beam, or in a second configuration in which the first laser beam includes a laser beam having a first wavelength and a first output, and the second laser beam includes a laser beam having the first wavelength and an output smaller than the first output, and/or being in a defocused state.

### CROSS-REFERENCE TO RELATED APPLICATION

This application is based upon and claims the benefit of priority from Japanese Patent Application No. 2023-071766 filed on Apr. 25, 2023, the content of which is incorporated herein by reference.

### BACKGROUND OF THE INVENTION

### Field of the Invention

The present invention relates to a laser welding method and a laser welding system.

### Description of the Related Art

In electrical equipment such as a rotating electrical machine and a power conversion device, it is necessary to cause a large current to flow with low resistance, and a thick conductive wire such as a square wire and a conductor plate are used, and they are joined together for use (see, for example, Japanese Patent No. 7162144). In a case where tough pitch copper or the like having a relatively high oxygen content is used for such a conductive wire or a conductor plate, a large amount of blow holes are formed in a welded part, and insufficient strength and an increase in electrical resistance can be concerns. Hence, in the welding method described in Japanese Patent No. 7162144, by adding a filler material (a deoxidizing material) containing phosphorus while melting a conductor to be joined, welding is enabled while suppressing the formation of the blow holes.

In the joining with use of the deoxidizing material, however, the cycle time of the joining is extended, and the material cost of the deoxidizing material is also needed, thereby leading to increases in processing cost. In addition, the influence of the deoxidizing material also causes a decrease in conductivity.

### SUMMARY OF THE INVENTION

An aspect of the present invention is a laser welding method for performing a laser welding by irradiating a target to be processed with a laser beam. The method includes: a first step of irradiating the target with a first laser beam to melt the target; and a second step of irradiating a melting region melted in the first step with a second laser beam different from the first laser beam to maintain a melting amount of the melting region. The first laser beam is irradiated in a first laser beam configuration in which an output of the first laser beam is lowered by a predetermined amount when a predetermined time elapses from a start of irradiation of the first laser beam, and an output of the second laser beam is set to be smaller than the output of the first laser beam, or in a second laser beam configuration in which the first laser beam includes a laser beam having a first wavelength of 800 nm or more and 1200 nm or less and a first output, and the second laser beam includes a laser beam having the first wavelength and an output smaller than the first output, and/or being in a defocused state.

Another aspect of the present invention is a laser welding system including: a first laser beam generation device configured to generate a first laser beam; a second laser beam generation device configured to generate a second laser beam different from the first laser beam; an optical device configured to irradiate a target to be processed with the first laser beams and the second laser beam; and a control apparatus configured to control operations of the first laser beam generation device, the second laser beam generation device, and the optical device. The control apparatus comprising a microprocessor and a memory connected to the microprocessor. The microprocessor is configured to perform: controlling the operations of the first laser beam generation device, the second laser beam generation device, and the optical device so as to irradiate the target with the first laser beam to melt the target, and to irradiate a region melted by the first laser beam with the second laser beam to maintain a melting amount of the region.

### BRIEF DESCRIPTION OF THE DRAWINGS

The objects, features, and advantages of the present invention will become clearer from the following description of embodiments in relation to the attached drawings, in which:

FIG. 1 is a block diagram illustrating a schematic configuration of a laser welding system in an embodiment of the present invention;

FIG. 2 is a view illustrating an example of a to-be-processed target by laser welding;

FIG. 3 is a flowchart for describing a control apparatus controlling the laser welding in the embodiment;

FIG. 4 is a schematic view illustrating a first scanning mode;

FIG. 5 is a view of end portions in which melting regions are formed when viewed from a lateral side of conductor;

FIG. 6 is a schematic view illustrating a second scanning mode;

FIG. 7 is a view of end portions in which a merged melting region is formed when viewed from the lateral side of the conductor;

FIG. 8 is a diagram illustrating graphs for qualitatively describing a relationship between laser beam irradiation, a melting amount, and a blow hole amount;

FIG. 9 is a view illustrating a blow hole released into the atmosphere;

FIG. 10 is a diagram for describing a first modification;

FIG. 11 is a diagram for describing a second modification;

FIG. 12 is a diagram illustrating an example of lowering output by a plurality of steps;

FIG. 13 is a diagram illustrating an example of lowering output continuously;

FIG. 14 is a diagram for describing a third modification;

FIG. 15 is a flowchart for describing a fourth modification; and

FIG. 16 is a view illustrating a case where plate members are overlaid and welded.

### DETAILED DESCRIPTION OF THE INVENTION

Hereinafter, embodiments of the present invention will be described below with reference to the drawings. The following description and drawings are examples for describing the present invention, and omissions and simplifications are made as appropriate for the sake of clarity of the description. In addition, in the following description, the same or similar elements and processes are denoted by the same reference numerals, and overlapping descriptions will be omitted, in some cases. Note that the contents to be described below are merely examples of embodiments in the present invention, and the present invention is not limited to the following embodiments, and can be implemented in other various modes.

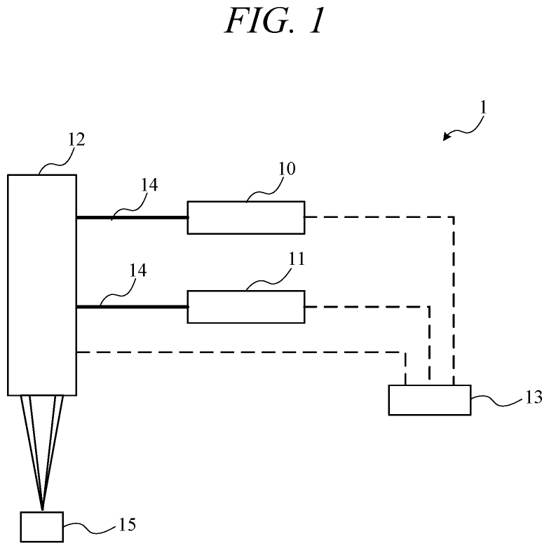

FIG. 1 is a block diagram illustrating a schematic configuration of a laser welding system 1 in the present embodiment. The laser welding system 1 includes a first laser beam generation device 10, a second laser beam generation device 11, an optical device 12, a control apparatus 13, and an optical fiber 14. Each of the laser beam generation devices 10 and 11 includes a laser oscillator. The laser beam generation device 10 generates a first wavelength laser beam having a wavelength of 800 nm or more and 1200 nm or less. The laser beam generation device 11 generates a second wavelength laser beam having a wavelength of 400 nm or more and 500 nm or less.

The optical fiber 14 guides the laser beams that have been output from the laser beam generation devices 10 and 11 to the optical device 12. The optical device 12 is an optical system for irradiating a to-be-processed target 15 with the laser beams that have been input from the laser beam generation devices 10 and 11. Although not illustrated, the optical device 12 includes a collimator lens, a condenser lens, a mirror, a filter, and the like. The optical device 12 is configured to be capable of scanning the laser beam on the to-be-processed target 15.

The control apparatus 13 controls operations of the laser beam generation devices 10 and 11 and the optical device 12. The control apparatus 13 includes a CPU, a memory (such as a RAM or a ROM), and the like, and executes a program stored in the memory on the CPU to control the laser welding system 1. The control apparatus 13 controls the laser beam generation devices 10 and 11 to output the laser beams. The control apparatus 13 controls the optical device 12 for a focal position and a scanning path of the laser beam.

The above-described first wavelength laser beam having a wavelength of 800 nm or more and 1200 nm or less denotes a laser beam in a wavelength range generally called an IR laser beam. In addition, the second wavelength laser beam having a wavelength of 400 nm or more and 500 nm or less denotes a laser beam in a wavelength range called a BLUE laser beam. In comparison between the first wavelength laser beam and the second wavelength laser beam, the first wavelength laser beam has a smaller spot diameter and a higher output density, but has a lower absorption rate in the to-be-processed target 15. On the other hand, the second wavelength laser beam has a larger spot diameter and a lower output density, but has a higher absorption rate in the to-be-processed target 15.

Therefore, when a to-be-processed target is scanned with the laser beams including the first wavelength laser beam and the second wavelength laser beam, a region on a scanning path is irradiated with the second wavelength laser beam having a larger spot diameter, and is then irradiated with the first wavelength laser beam. That is, by irradiating with the second wavelength laser beam having a lower power density but a higher absorption rate, and then irradiating with the first wavelength laser beam having a higher power density, it becomes possible to achieve improvements in sputtering and generation of blow holes. In the present embodiment, the to-be-processed target 15 is caused to melt by use of laser beams including the first wavelength laser beam and the second wavelength laser beam, and in addition, a welding method to be described later is adopted to further reduce the generation of the blow holes.

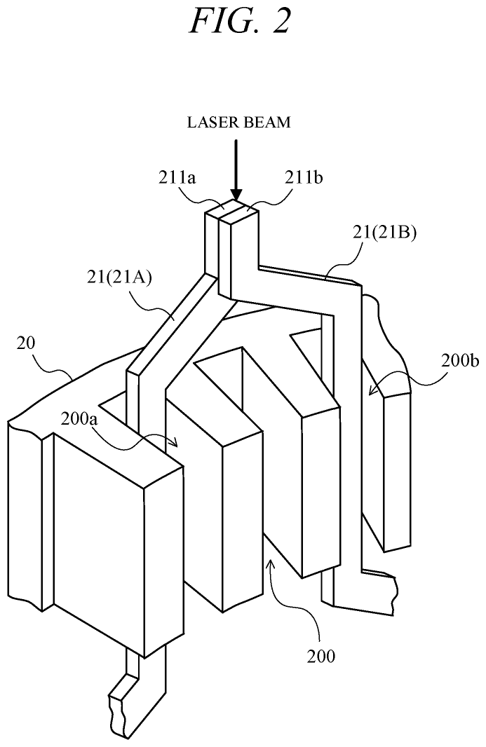

FIG. 2 is a view illustrating an example of the to-be-processed target 15 by laser welding. FIG. 2 is a view illustrating a part of a stator coil 21, which is provided in a stator core 20 of a motor. The stator core 20 is constituted by stacking electromagnetic steel plates. A plurality of slots 200 are formed in the stator core 20. The stator coil 21 is disposed in each slot 200. The stator coil 21 is formed of a plurality of segment coils that are connected. In the example illustrated in FIG. 2, from among the plurality of segment coils constituting the stator coil 21, a pair of segment coils 21A and 21B, which are connected with each other, are illustrated.

The segment coil 21A is inserted into a slot 200a, and the segment coil 21B is inserted into a slot 200b. An end portion 211a of the segment coil 21A is arranged side by side to be adjacent to an end portion 211b of the segment coil 21B. The end portion 211a and the end portion 211b are joined with each other by laser welding. The laser beam is irradiated on end surfaces of the end portion 211a and the end portion 211b.

Oxygen-free copper having a low oxygen content is generally used for the stator coil 21. In a case where tough pitch copper is used instead of the oxygen-free copper in order to reduce the cost, there is a problem that many blow holes are formed in the welded part as described in Japanese Patent No. 7162144. The tough pitch copper has a higher oxygen content than that of the oxygen-free copper. For example, in the case of the oxygen-free copper, the content of oxygen is 10 ppm or less, but in the case of the tough pitch copper, oxygen of approximately 300 to 500 ppm is contained. When the tough pitch copper melts, the contained oxygen is combined with hydrogen, and water vapor is generated. Such water vapor is considered to be a cause of the blow holes. In the present embodiment, the generation of the blow holes is suppressed by performing the laser welding in a method to be described below.

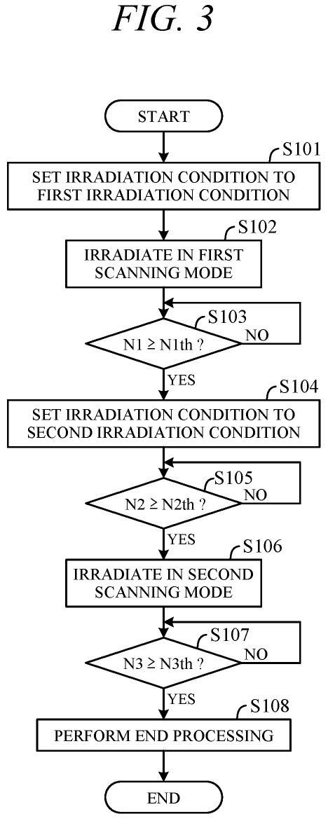

FIG. 3 is a flowchart for describing the control apparatus 13 controlling the laser welding. In step S101, the control apparatus 13 sets an irradiation condition of the laser beam to be irradiated on the to-be-processed target 15 to a first irradiation condition. Under the first irradiation condition in an embodiment, the first wavelength laser beam of the laser beam generation device 10 and the second wavelength laser beam of the laser beam generation device 11 are simultaneously irradiated. Furthermore, the output of the second wavelength laser beam is set to an output for maintaining a melting amount M of a merged melting region S3 at a predetermined melting amount Mth, as will be described later. On the other hand, the output of the first wavelength laser beam is set to an output capable of melting the to-be-processed target 15 (a coil conductor), when the first wavelength laser beam and the second wavelength laser beam of the above output are irradiated on the to-be-processed target 15. For example, the output is set to be capable of melting the coil conductor only with the first wavelength laser beam. Hereinafter, the laser beam under the first irradiation condition will be referred to as a first laser beam LL1.

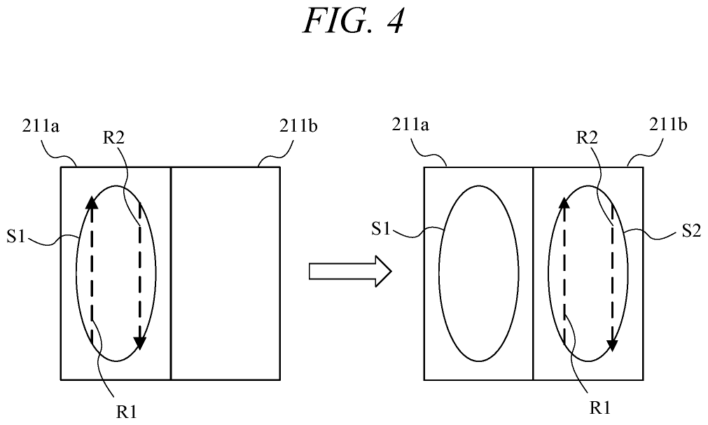

In step S102, the end surfaces of the end portions 211a and 211b of the segment coils 21A and 21B are irradiated with the first laser beam LL1 in a first scanning mode as illustrated in FIG. 4. FIG. 4 is a schematic view illustrating the first scanning mode, and illustrates a view (a top view) when the end surfaces of the end portions 211a and 211b are viewed from above. Arrows R1 and R2 indicate the scanning paths of the first laser beam LL1.

In the first scanning mode, first, the spot of the first laser beam LL1 is reciprocated on the end surface of one end portion 211a, as indicated by the scanning paths R1 and R2. Accordingly, the conductor of the end portion 211a melts, and a melting region S1 is formed. Next, the spot of the first laser beam LL1 is reciprocated on the end surface of the other end portion 211b, as indicated by scanning paths R1 and R2. Accordingly, the conductor of the end portion 211b melts, and another melting region S2 is formed on the end surface of the end portion 211b.

Note that as a pattern for alternately scanning the end portions 211a and 211b, the end portions 211a and 211b may be reciprocally scanned one time alternately like 211a→211b→211a→211b . . . , or may be reciprocally scanned a plurality of times alternately like 211a→211a→211b→211b→211a→211a→211b→211b . . . . In addition, a reciprocal scan of one time and a reciprocal scan of a plurality of times may be used in combination.

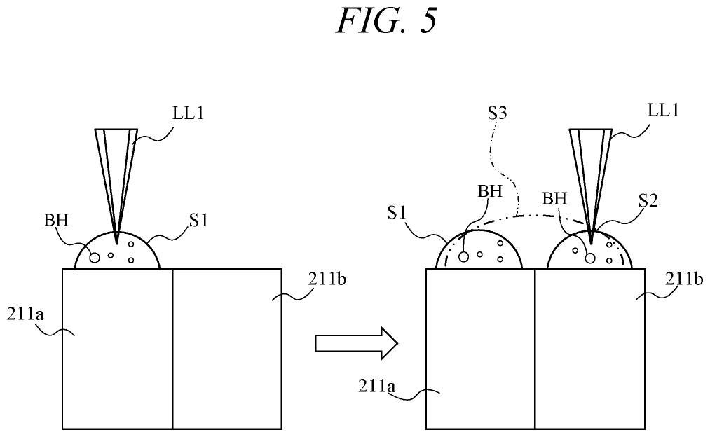

FIG. 5 is a view of the end portions 211a and 211b in which the melting regions S1 and S2 are formed, when viewed from a lateral side of the conductor. The end surface of the end portion 211a is reciprocally scanned with the first laser beam LL1, and consequently, a part of the end portion 211a melts and a melting region S1 is formed. Next, the end surface of the end portion 211b is reciprocally scanned with the first laser beam LL1, and consequently, a part of the end portion 211b melts and a melting region S2 is formed. Whenever the laser beam irradiation is repeated on each of the end portions 211a and 211b, the melting amounts of the melting regions S1 and S2 increase. The blow holes BH are generated, as the end portions 211a and 211b melt. Note that in the present embodiment, bubbles generated in the melting region and pores generated in the welded part will be collectively referred to as blow holes.

Returning to FIG. 3, in step S103, the control apparatus 13 determines whether the number of reciprocal scan times N1 in the first scanning mode (reciprocal scan) on each of the end portions 211a and 211b has reached a predetermined number of times N1th that has been preset. The melting amount of each of the melting regions S1 and S2 illustrated in FIG. 5 increases, as the number of scan times N1 increases. The melting regions S1 and S2, which have been separated from each other, are merged into one region. The melting region S3, which is indicated by a two-dot chain line, indicates a melting region after being merged, and will be hereinafter referred to as the merged melting region S3. The merged melting region S3 is formed to cross over the end surface of the end portion 211a and the end surface of the end portion 211b.

The predetermined number of times N1th in step S103 is set in consideration of a timing when the melting amount of each of the melting regions S1 and S2 formed in each of the end portions 211a and 211b increases and the melting regions S1 and S2 are merged into one region that is the merged melting region S3. That is, the predetermined number of times N1th is set to the number of times that the merged melting region S3 is formed definitely when the reciprocal scanning is performed the predetermined number of times N1th.

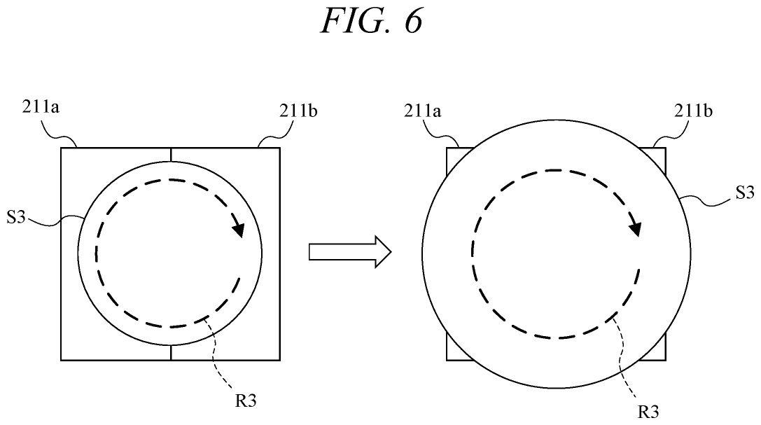

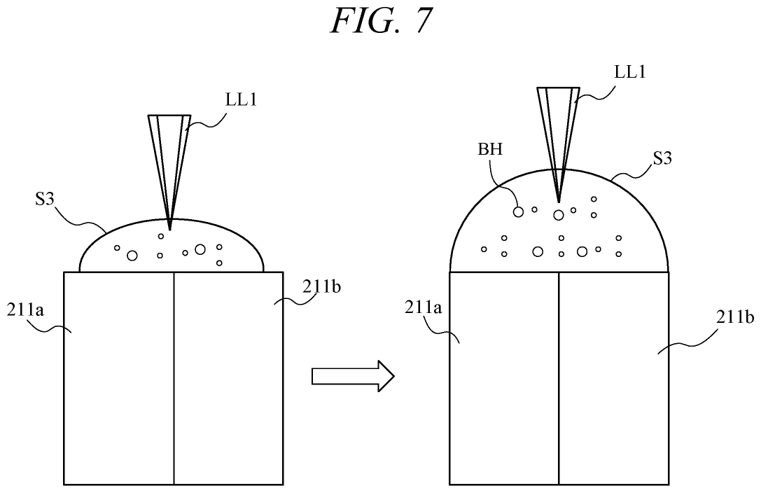

The processing of step S103 is repeatedly performed until the number of scan times on each of the end portions 211a and 211b reaches the predetermined number of times N1th, and in a case where N1≥N1th is determined in step S103, the processing proceeds to step S104. In step S104, the entirety of the merged melting region S3 is irradiated with the first laser beam LL1 in a second scanning mode as illustrated in FIG. 6. In the second scanning mode, each of the end portions 211a and 211b is irradiated with the first laser beam LL1 so as to cross over the boundary between the end portions 211a and 211b, which are adjacent to each other, on a circular scanning path as indicated by a broken line R3. The melting amount of the merged melting region S3 increases, as the first laser beam LL1 is irradiated. FIG. 7 is a view of the end portions 211a and 211b, in which the merged melting region S3 is formed, when viewed from the lateral side of the conductor. As the melting amount M of the merged melting region S3 increases, the amount of the blow holes BH to be generated also increases.

In step S105 of FIG. 3, the control apparatus 13 determines whether the number of scan times N2 in the second scanning mode has reached a predetermined number of times N2th. The predetermined number of times N2th in this case is set to the number of times when the melting amount M of the merged melting region S3 reaches the predetermined melting amount Mth. The processing of step S105 is repeatedly performed until the number of scan times N2 reaches the predetermined number of times N2th, and in a case where N2≥N2th is determined in step S105, the processing proceeds to step S106.

In step S106, the control apparatus 13 changes the setting of the irradiation condition of the irradiated laser beam from the first irradiation condition to a second irradiation condition. Note that regarding the scanning mode, the second scanning mode continues. Under the second irradiation condition in an embodiment, the first wavelength laser beam of the laser beam generation device 10 is stopped, and only the second wavelength laser beam of the laser beam generation device 11 is irradiated. Note that the output of the second wavelength laser beam is set to be identical to that of the first irradiation condition (the output for maintaining the melting amount M of the merged melting region S3 at the predetermined melting amount Mth). Hereinafter, the laser beam under the second irradiation condition will be referred to as a second laser beam LL2.

Here, the output for maintaining the merged melting region S3 corresponds to an output for maintaining the melting amount M of the merged melting region S3 without an increase, when the second laser beam LL2 in the second scanning mode illustrated in FIG. 6 is irradiated on the merged melting region S3. In this case, neither the end portion 211a nor 211b newly melts, and the melting amount M of the merged melting region S3 is maintained at the predetermined melting amount Mth.

In step S107, the control apparatus 13 determines whether the number of scan times N3 of the second laser beam LL2 has reached a predetermined number of times N3th. Then, the processing of step S107 is repeatedly performed until the number of scan times N3 reaches the predetermined number of times N3th, and in a case where N3≥N3th is determined in step S107, the processing proceeds to step S108. In step S108, the irradiation of the second laser beam LL2 is stopped, end processing of the laser welding is performed, and the series of pieces of laser welding processing ends.

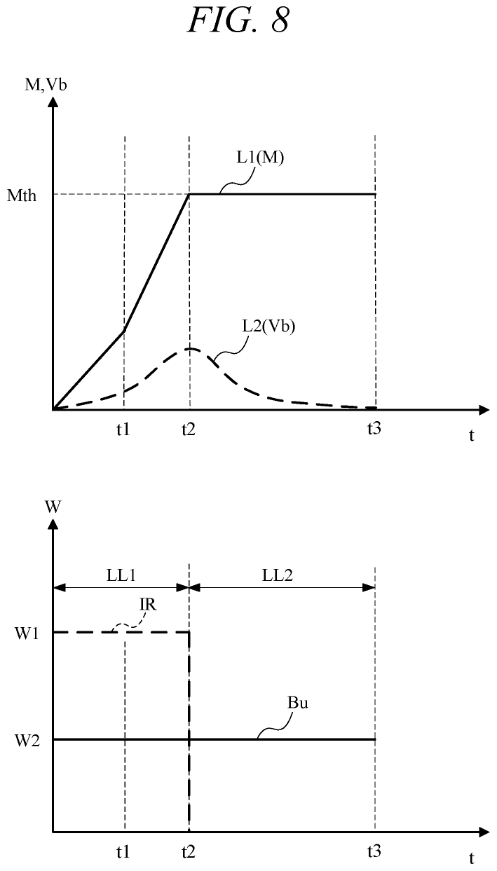

FIG. 8 illustrates graphs for qualitatively describing a relationship between laser beam irradiation, a melting amount, and a blow hole amount. The graph on an upper side in the drawing indicates temporal transition of a melting amount M and a blow hole amount Vb, and the graph on a lower side in the drawing indicates temporal transition of an output W of the laser beam. Irradiation with the first laser beam LL1 is performed from time t=0 to time t2, and irradiation with the second laser beam LL2 is performed from time t2 to time t3. The first laser beam LL1 includes a first wavelength laser beam IR having an output W1 and a second wavelength laser beam Bu having an output W2. On the other hand, the second laser beam LL2 includes only the second wavelength laser beam Bu having the output W2.

A line L1 indicates the melting amount M, and a line L2 indicates the blow hole amount Vb to be estimated. In the line L1 indicating the melting amount M, its inclination changes (increases) at time t1. It is considered that this is because the melting region spreads almost over the entire end surfaces of the end portions 211a and 211b, and the absorption rate of the laser beam on a to-be-processed target increases. When the irradiated laser beam is changed from the first laser beam LL1 to the second laser beam LL2 at time t2, the melting amount M stops increasing, and is maintained at the predetermined melting amount Mth.

It is considered that the amount of the blow holes BH (the blow hole amount Vb) included in the melting region increases depending on the newly melting amount M in the conductor. Therefore, the blow hole amount Vb increases with the lapse of time from the start of welding to nearly time t2, while the melting amount M is increasing. On the other hand, when the irradiated laser beam is changed from the first laser beam LL1 to the second laser beam LL2, only the second wavelength laser beam Bu having the output W2 is irradiated on the melting region (the merged melting region S3). The second wavelength laser beam Bu has a larger spot diameter and a lower output density, and thus works such that the conductor does not newly melt and the melting state of the melting region is maintained.

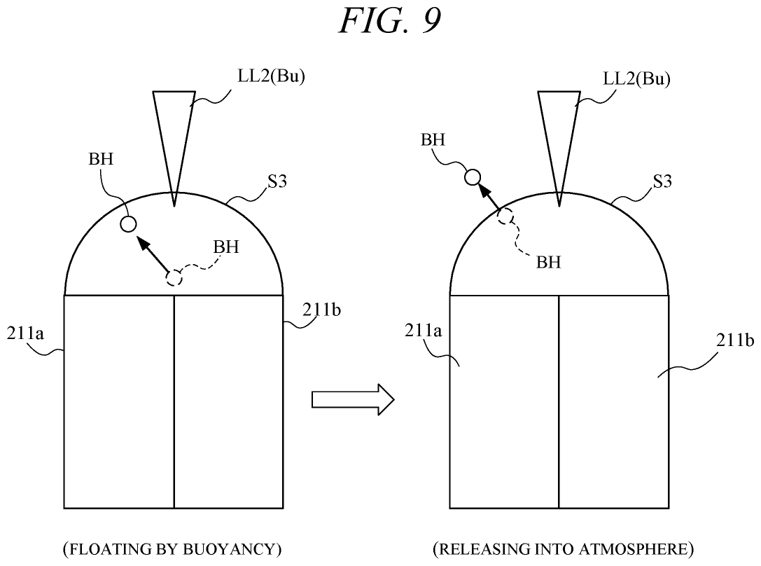

In a state in which the conductor does not newly melt and the melting amount M is kept constant, no blow hole BH is newly generated. On the other hand, the blow hole BH already present in the melting region (the merged melting region S3) is moved by buoyancy toward the surface of the merged melting region S3, as illustrated in FIG. 9. The blow hole BH that has reached the surface of the merged melting region S3 is released from the surface of the merged melting region S3 into the atmosphere. In a state in which the melting amount M is kept constant, such a blow hole BH is released into the atmosphere, and consequently, the blow hole amount Vb in the merged melting region S3 decreases as indicated by a line L2 in FIG. 8. The irradiation time of the second laser beam LL2, that is, the time while the melting amount M is kept constant (Mth) is set in accordance with a release rate of the blow hole BH.

As described above, in the present embodiment, the second laser beam LL2 is irradiated on the melting region to maintain the melting amount M and to promote the release of the blow holes BH into the atmosphere, so that the blow holes BH in the merged melting region S3 are reduced. As a result, the amount of the blow holes BH (the blow hole amount Vb) that remain in the welded part of the end portions 211a and 211b can be reduced as compared with the conventional case, so that the joining strength of the welded part can be improved. In addition, no deoxidizing material is used like the technique described in Japanese Patent No. 7162144, and thus an increase in the processing cost and a decrease in conductivity can be prevented.

In the above-described embodiments, the first laser beam LL1 includes the first wavelength laser beam IR having a wavelength of 800 nm or more and 1200 nm or less and the second wavelength laser beam Bu having a wavelength of 400 nm or more and 500 nm or less, and the second laser beam LL2 is configured to include only the second wavelength laser beam Bu. However, the configurations of the first laser beam LL1 and the second laser beam LL2 are not limited to them. Hereinafter, other examples (first to fourth modifications) will be described. Note that in the first to third modifications, the flowchart related to the control as illustrated in FIG. 3 is omitted, but the irradiation condition or the like may be appropriately changed in accordance with a content in a modification.

### (First Modification)

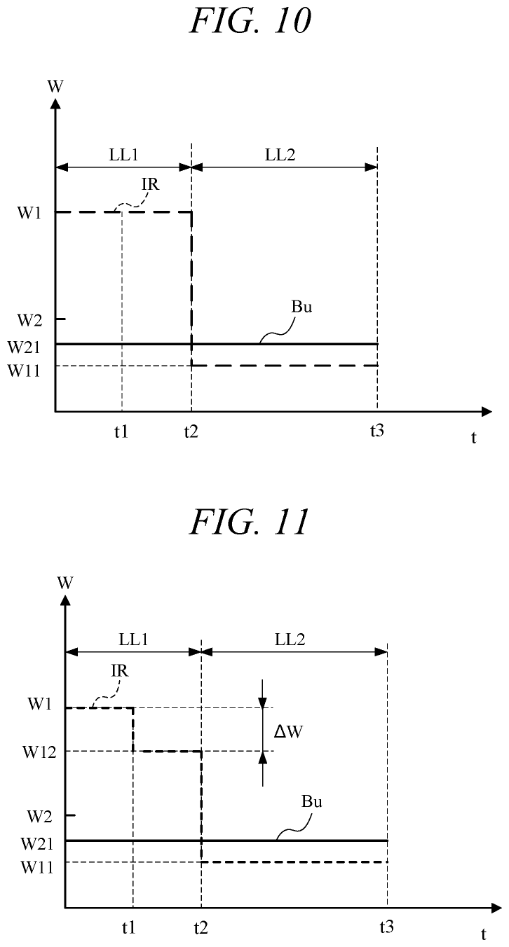

FIG. 10 is a diagram for describing a first laser beam LL1 and a second laser beam LL2 in a first modification. In the first modification, the second laser beam LL2 also includes the first wavelength laser beam IR and the second wavelength laser beam Bu. In addition, it is assumed that W1 is set as the output of the first wavelength laser beam IR in the first laser beam LL1, and W11 (<W1) is set as the output of the first wavelength laser beam IR in the second laser beam LL2. Further, the first wavelength laser beam IR having the output W11 is included in the second laser beam LL2, and the output of the second wavelength laser beam Bu is set to W21 (<W2). With the settings in this manner, the total output of the second laser beam LL2 can be set to an output for maintaining the melting amount M of the merged melting region S3 at the predetermined melting amount Mth. If a blow hole is generated at a deep position in the melting region, heat input into a deep part in the melting region will be insufficient only with the second wavelength laser beam Bu, and the blow hole will be solidified before it is released. Therefore, the output of the first wavelength laser beam IR is lowered to such an extent that no new blow hole is generated (the output W11), and is then irradiated, so that the blow hole can be released while the melting state at the deep position is maintained.

In addition, instead of lowering the output of the first wavelength laser beam IR in the second laser beam LL2, the first wavelength laser beam IR may be irradiated in a defocused state. By irradiating in the defocused state, the spot diameter of the first wavelength laser beam IR is enlarged, and the output density is lowered. Therefore, it becomes possible to apply energy, while preventing the conductor from newly melting due to the first wavelength laser beam IR. Note that not only the first wavelength laser beam IR but also the second wavelength laser beam Bu may be simultaneously defocused.

In addition, in the second laser beam LL2, the output of the first wavelength laser beam IR may be lowered and the first wavelength laser beam IR may also be irradiated in the defocused state. Furthermore, the output of the second wavelength laser beam Bu included in the second laser beam LL2 may also be made lower than the output of the second wavelength laser beam Bu included in the first laser beam LL1.

### (Second Modification)

FIG. 11 is a diagram for describing a first laser beam LL1 and a second laser beam LL2 in a second modification. In the second modification, in the first laser beam LL1 of the above-described first modification (FIG. 10), the output of the first wavelength laser beam IR included in the first laser beam LL1 is lowered by a predetermined amount ΔW from the output W1 to an output W12 (W1>W12>W11) at time t1. Other configurations are similar to those in the above-described first modification.

It has been known that the absorption rate of the laser beam increases, as the temperature of the copper that is a to-be-processed target increases, and that the absorption rate increases in a stepwise manner, when the copper changes to a melting state from a solid state. Time t1 is a timing that is set in accordance with an increase in the absorption rate of the laser beam, and the output of the first wavelength laser beam IR included in the first laser beam LL1 is lowered from W1 to W12 in accordance with such a timing. When the absorption rate of the laser beam increases, melting by the first laser beam LL1 rapidly increases. Hence, in the second modification, in order to suppress a rapid increase of the blow holes due to such a rapid increase of the melting, the output of the first laser beam LL1 is lowered by the predetermined amount ΔW.

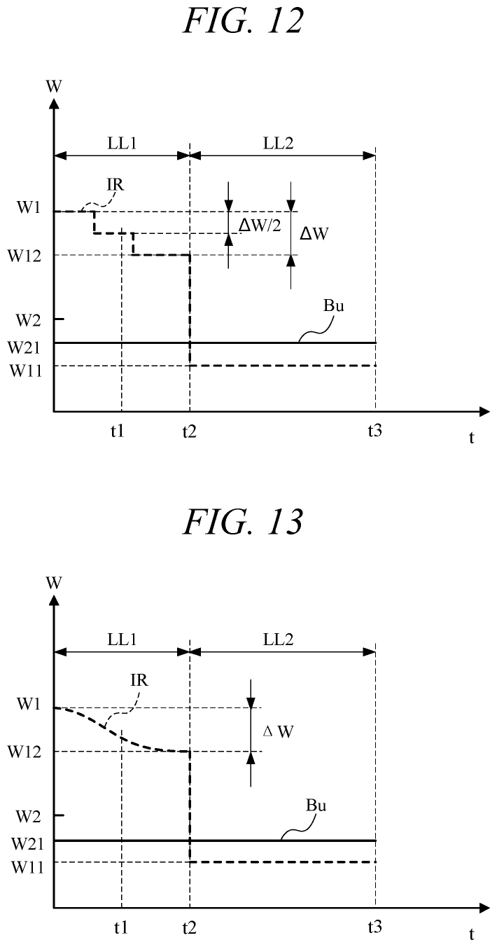

In FIG. 11, the output of the first laser beam LL1 is lowered by the predetermined amount ΔW in one step. However, as illustrated in FIG. 12, the output of the first laser beam LL1 may be lowered in two steps of ΔW/2 each. It is needless to say that three or more steps may be used. Furthermore, as illustrated in FIG. 13, the output of the first laser beam LL1 may be continuously and smoothly lowered by the predetermined amount ΔW. As a result, it becomes possible to cause the output of the first laser beam LL1 to follow the change in the absorption rate in a more appropriate manner, so that the generation of the blow hole can be more effectively suppressed.

When the output of the first laser beam LL1 is lowered in a stepwise manner as illustrated in FIGS. 11 and 12, a single unit is set to one cycle of irradiation including a combination of the irradiation in reciprocal movement on the end portion 211a (reciprocal scan) and the irradiation in reciprocal movement on the end portion 211b (reciprocal scan) illustrated in FIG. 4, and the output is lowered in every “n” (n=1, 2, 3, . . . ) units. By lowering the output in the unit of cycle in this manner, the melting state of each end portion can be made into a uniform state.

Note that also regarding the first laser beam LL1 and the second laser beam LL2 in FIG. 8, similarly to the case of FIGS. 11 to 13 in contrast to FIG. 10, the output of the first wavelength laser beam IR included in the first laser beam LL1 may be lowered in a stepwise or continuous manner from W1 to W12 at time t1.

### (Third Modification)

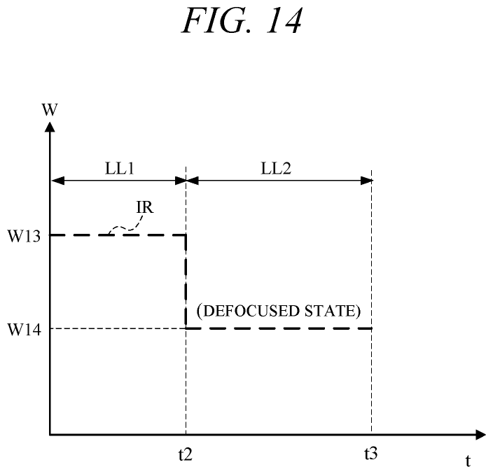

FIG. 14 is a diagram for describing a first laser beam LL1 and a second laser beam LL2 in a third modification. In the third modification, the first laser beam LL1 and the second laser beam LL2 each includes only the first wavelength laser beam IR. It is assumed that W13 is set as the output of the first wavelength laser beam IR in the first laser beam LL1. The output W13 may be the same as the output W1 illustrated in FIG. 8, or may be set to be slightly higher. It is assumed that W14 is set as the output of the first wavelength laser beam IR in the second laser beam LL2. In addition, the first wavelength laser beam IR is irradiated in a defocused state, the spot diameter is increased, and the output density of the first wavelength laser beam IR is lowered.

In this manner, in the third modification, the second laser beam LL2 includes only the first wavelength laser beam IR. However, the output is lowered, and the output density is also lowered by defocusing, so that the melting amount M of the merged melting region S3 is kept constant. Note that the first wavelength laser beam IR of the second laser beam LL2 may be configured to simply lower the output, or may be simply irradiated in the defocused state. In addition, also in the third modification of FIG. 14, similarly to the cases of FIGS. 11 to 13 in contrast to FIG. 10, the output of the first wavelength laser beam IR included in the first laser beam LL1 may be lowered in a stepwise or continuous manner from W1 to W12 at time t1.

### (Fourth Modification)

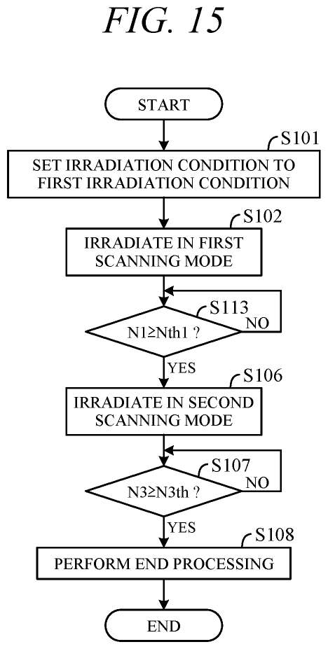

FIG. 15 is a flowchart for describing a fourth modification. The flowchart of FIG. 15 is obtained by deleting step S103, step S104, and step S105 and adding step S113 in the flowchart of FIG. 3. The processing of steps other than step S113 is similar to the processing of steps having the same numerals in FIG. 3. Hereinafter, steps after step S113 will be mainly described.

In step S102, as described above, irradiation of the first laser beam LL1 in the first scanning mode starts on the end surfaces of the end portions 211a and 211b of the segment coils 21A and 21B. The melting amount of each of the melting regions S1 and S2 illustrated in FIG. 5 increases, as the number of scan times N1 increases. Then, the melting regions S1 and S2, which have been separated from each other, are merged into one region, and become the merged melting region S3, which crosses over the end surface of the end portion 211a and the end surface of the end portion 211b.

In step S113, the control apparatus 13 determines whether the number of scan times N1 in the first scanning mode has reached a predetermined number of times Nth1. Such a predetermined number of times Nth1 is set to the number of times when the melting amount M of the merged melting region S3 reaches the predetermined melting amount Mth. The processing of step S113 is repeatedly performed until the number of scan times N1 becomes the predetermined number of times Nth1, and in a case where N1≥Nth1 is determined in step S113, the processing proceeds to step S106.

In step S106, the control apparatus 13 changes the setting of the irradiation condition of the irradiated laser beam from the first irradiation condition (the first laser beam LL1) to the second irradiation condition (the second laser beam LL2). Note that regarding the scanning mode, the first scanning mode continues. In step S107, it is determined whether the number of scan times N3 of the second laser beam LL2 has reached the predetermined number of times N3th, and in a case where N3≥N3th is determined, the processing proceeds to step S108. In step S108, the irradiation of the second laser beam LL2 is stopped, end processing of the laser welding is performed, and the series of pieces of laser welding processing ends.

In the scanning control of the laser beam illustrated in FIG. 3, when the melting regions become the merged melting region S3, the reciprocal scan (the first scanning mode) is changed to the circular scanning path (the second scanning mode). On the other hand, in the fourth modification, changing the scanning mode is not needed, and the scanning control is simpler.

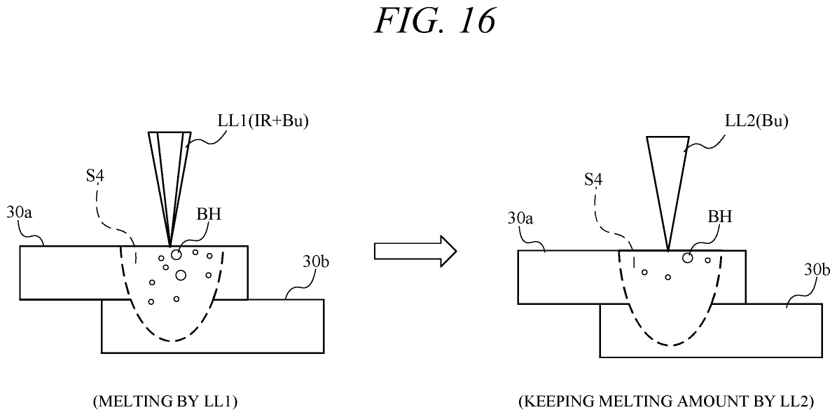

Note that in the above-described embodiments, the laser welding has been described with an example of the case of joining the stator coil of the motor. However, the laser welding method in the present invention is not limited to the case of joining the stator coil, and is applicable to welding various to-be-processed targets. For example, the present invention is also applicable to a case where plate members 30a and 30b are overlaid and welded, as illustrated in FIG. 16. First, the first laser beam LL1 is irradiated to form a melting region S4, which crosses over both the plate member 30a and the plate member 30b. Next, the second laser beam LL2 is irradiated on the melting region S4 to keep the melting amount constant. In the period during which the melting amount is maintained, the blow holes BH in the melting region S4 are released into the atmosphere, and the blow holes in the welded part can be reduced.

According to the embodiments and the modifications in the present invention that have been described above, the following operations and effects are obtainable.
(1) As illustrated in FIGS. 5, 7, 11 to 14 and the like, the laser welding method includes a first step of irradiating the end portions 211a and 211b, which are to-be-processed targets, with the first laser beam LL1 to melt the end portions 211a and 211b, and a second step of irradiating the melting region (the merged melting region S3) that has melted in the first step with the second laser beam LL2 having an irradiation condition different from that of the first laser beam LL1 to maintain the melting amount of the merged melting region S3.

The laser beam is irradiated in a first laser beam configuration (A) or a second laser beam configuration (B) in the following. In the first laser beam configuration (A), for example, as illustrated in FIGS. 11 to 13, when a predetermined time elapses from the start of irradiation of the first laser beam LL1, the output of the first laser beam LL1 is lowered by a predetermined amount, and the output of the second laser beam LL2 is set to be smaller than the output of the first laser beam LL1. In the second laser beam configuration (B), as illustrated in FIG. 14, the first laser beam LL1 includes the first wavelength laser beam IR having the first wavelength of 800 nm or more and 1200 nm or less and the output W13, and the second laser beam LL2 includes the first wavelength laser beam IR having the first wavelength and the output smaller than the output W13 and/or being in the defocused state.

In this manner, in the second step, the melting amount of the merged melting region S3 is maintained, so that it becomes possible to stop a new blow hole from being generated by melting. In addition, the blow holes in the melting region are moved by buoyancy toward the surface of the melting region, and are released from the surface of the melting region into the atmosphere. As a result, the blow holes in the melting region are reduced, and remaining blow holes in the welded part are reduced, so that the joining strength of the welded part can be improved. In addition, no deoxidizing material is used, and an increase in cost and a decrease in conductivity can be suppressed.
(2) In addition, as illustrated in FIGS. 4 to 7 and the like, the to-be-processed target includes the conductor end portions (the end portions 211a and 211b) of a plurality of conductors (the segment coils 21A and 21B) that are arranged side by side, and the end portions 211a and 211b are individually irradiated with the laser beam as illustrated in FIG. 4 until the melting regions S1 and S2, which are formed in each of the end portions 211a and 211b, are merged to form one merged melting region S3. After the merged melting region S3 is formed, the laser beam is scanned to cross over each of the end portions 211a and 211b as illustrated in FIG. 6.

The surface of a conductor such as a stator coil of the motor is coated with enamel or the like. Hence, in a case where the end surfaces of the end portions 211a and 211b are irradiated with a laser beam for welding, if the laser beam is scanned to cross over both of the end portions 211a and 211b, the coating will be damaged by the laser beam irradiation, and will be adversely affected.

As described above, the end portions 211a and 211b are individually irradiated with the laser beam as illustrated in FIG. 4 until the melting regions S1 and S2, which are formed on the respective end surfaces, are merged, so that the coating can be prevented from being irradiated with the laser beam. On the other hand, once the merged melting region S3 is formed, the coating of the boundary region between the end portions 211a and 211b is covered with the merged melting region S3. Therefore, as illustrated in FIG. 6, even though the laser beam is scanned to cross over each of the end portions 211a and 211b, the coating is unlikely to be irradiated with the laser beam. As a result, the coating can be prevented from being damaged by the laser beam. Note that in order to further simplify the scanning control, also after the merged melting region S3 is formed, as illustrated in FIG. 15 and the like, the end portions 211a and 211b may be individually irradiated with the laser beam. That is to say, in both the first step and the second step, the conductor end portions may be individually scanned with the laser beam.
(3) Further, as illustrated in FIG. 8 and the like, the first laser beam LL1 in the first laser beam configuration (A) includes the laser beam having the first wavelength and the output W1 and the laser beam having the second wavelength of 400 nm or more and 500 nm or less and the output W2, which is smaller than the output W1. The second laser beam LL2 in the first laser beam configuration (A) includes the laser beam having the second wavelength and the output W2. By setting the outputs in this manner, the amount of the blow holes BH (the blow hole amount Vb) that remain in the welded part of each end portion can be reduced as compared with the conventional case, so that the joining strength of the welded part can be improved.
(4) Furthermore, as illustrated in FIG. 14 and the like, in the first laser beam configuration (A), the output of the first laser beam LL1 is continuously and gradually lowered with the elapse of the irradiation time, and the output of the first laser beam LL1 is lowered by the predetermined amount. Alternatively, as illustrated in FIGS. 11 and 12 and the like, in the first laser beam configuration (A), the output of the first laser beam LL1 is lowered in a stepwise manner, and the output of the first laser beam LL1 is lowered by the predetermined amount. In a case where the to-be-processed targets are the conductor end portions (the end portions 211a and 211b), in irradiating each of the conductor end portions (the end portions 211a and 211b) with the first laser beam LL1, the output is lowered for every predetermined number of times “n” (n=1, 2, 3, . . . ) of reciprocal scan (one cycle of irradiation including the combination of the irradiation in reciprocal movement on the end portion 211a (reciprocal scan) and the irradiation in reciprocal movement on the end portion 211b (reciprocal scan)), and the output of the first laser beam LL1 is lowered in a stepwise manner. More specifically, the output of the first laser beam LL1 is lowered, whenever the reciprocal scan with the first laser beam LL1, including the irradiation in the reciprocating movement on the end portion 211a and the irradiation in the reciprocating movement on the end portion 211b, is performed a predetermined number of times. By lowering the output in the unit of cycle in this manner, the melting state of each end portion can be made into a uniform state.

The above embodiment can be combined as desired with one or more of the aforesaid modifications. The modifications can also be combined with one another.

According to the present invention, the blow holes can be reduced, while an increase in processing cost and a decrease in conductivity are prevented.

Above, while the present invention has been described with reference to the preferred embodiments thereof, it will be understood, by those skilled in the art, that various changes and modifications may be made thereto without departing from the scope of the appended claims.

What is claimed is:

1. A laser welding method for performing a laser welding by irradiating a target to be processed with a laser beam, comprising:
a first step of irradiating the target with a first laser beam to melt the target; and
a second step of irradiating a melting region melted in the first step with a second laser beam different from the first laser beam to maintain a melting amount of the melting region, wherein,
the first laser beam is irradiated in a first laser beam configuration in which an output of the first laser beam is lowered by a predetermined amount when a predetermined time elapses from a start of irradiation of the first laser beam, and an output of the second laser beam is set to be smaller than the output of the first laser beam, or in a second laser beam configuration in which the first laser beam includes a laser beam having a first wavelength of 800 nm or more and 1200 nm or less and a first output, and the second laser beam includes a laser beam having the first wavelength and an output smaller than the first output, and/or being in a defocused state.

2. The laser welding method according to claim 1, wherein
in the first laser beam configuration, the output of the first laser beam is continuously and gradually lowered with an elapse of an irradiation time so that the output of the first laser beam is lowered by the predetermined amount.

3. The laser welding method according to claim 1, wherein
the target has conductor end portions of a plurality of conductors arranged side by side,
in the first laser beam configuration,
the output of the first laser beam is lowered in a stepwise manner so that the output of the first laser beam is lowered by the predetermined amount, and
in irradiating each of the conductor end portions with the first laser beam, so that the output of the first laser beam is lowered in a stepwise manner, the output of the first laser beam is lowered for every predetermined number of times of a reciprocal scan.

4. The laser welding method according to claim 3, wherein
the conductor end portions include a first conductor end portion and a second conductor end portion, and
in the first laser beam configuration, so that the output of the first laser beam is lowered in a stepwise manner, the output of the first laser beam is lowered for every predetermined number of times of the reciprocal scan including the irradiation in a reciprocating movement on the first conductor end portion and the irradiation in a reciprocating movement on the second conductor end portion.

5. The laser welding method according to claim 1, wherein
the first laser beam in the first laser beam configuration includes a laser beam having the first wavelength and a second output and a laser beam having a second wavelength of 400 nm or more and 500 nm or less and a third output smaller than the second output, and
the second laser beam in the first laser beam configuration includes a laser beam having the second wavelength and the third output.

6. The laser welding method according to claim 1, wherein
the target has conductor end portions of a plurality of conductors arranged side by side,
in the first step and the second step, the conductor end portions are individually scanned with the laser beam.

7. The laser welding method according to claim 1, wherein
the target has conductor end portions of a plurality of conductors arranged side by side,
the conductor end portions are individually irradiated with the laser beam until each melting region formed in each of the conductor end portions are merged to form one merged melting region,
after the merged melting region is formed, the laser beam is scanned to cross over each of the conductor end portions.

8. A laser welding system comprising:
a first laser beam generation device configured to generate a first laser beam;
a second laser beam generation device configured to generate a second laser beam different from the first laser beam;
an optical device configured to irradiate a target to be processed with the first laser beams and the second laser beam; and
a control apparatus configured to control operations of the first laser beam generation device, the second laser beam generation device, and the optical device, wherein the control apparatus comprising a microprocessor and a memory connected to the microprocessor, wherein
the microprocessor is configured to perform:
controlling the operations of the first laser beam generation device, the second laser beam generation device, and the optical device so as to irradiate the target with the first laser beam to melt the target, and to irradiate a region melted by the first laser beam with the second laser beam to maintain a melting amount of the region.
